(19) United States
(12) Patent Application Publication
(10) Pub. No.: US 2022/0065679 A1
(43) Pub. Date: Mar. 3, 2022

(54) LIQUID LEVEL GAGE WITH C-PLANE SAPPHIRE

(71) Applicant: Clark-Reliance Corporation, Strongsville, OH (US)

(72) Inventor: Steven R. McGuigan, Richfield, OH (US)

(21) Appl. No.: 17/002,322

(22) Filed: Aug. 25, 2020

(51) Int. Cl. G01F 23/16; E21B 41/02

(52) U.S. Cl. CPC G01F 23/162; G01M 3/3245; E21B 41/02

(57) ABSTRACT

The present invention provides a liquid level gage with C-plane sapphire. In an exemplary embodiment, the liquid level gage includes a hood assembly, a liquid column assembly, and an illuminator assembly. In an exemplary embodiment, the liquid column assembly includes a plurality of gage body assemblies. In an exemplary embodiment, each gage body assembly includes a body, a front port assembly, and a rear port assembly. In an exemplary embodiment, each front port assembly and each rear port assembly includes a glass module and a nut module. In an exemplary embodiment, each glass module includes a glass disk. In an exemplary embodiment, each glass disk is formed from C-plane sapphire.

### FIELD

The present invention relates generally to a liquid level gage, and, more particularly, to a liquid level gage with C-plane sapphire.

### BACKGROUND

Liquid level gages are known. Known liquid level gages include glass disks and mica shields. Difficulties can arise in the manufacture and use of liquid level gages with glass disks and mica shields.

### SUMMARY

The present invention provides a liquid level gage with C-plane sapphire.

In an exemplary embodiment, the liquid level gage comprises a gage body assembly. The gage body assembly includes a body, a front port assembly, and a rear port assembly. The body includes a longitudinal portion and a transverse portion. The longitudinal portion includes a top end and a bottom end. The top end includes a top opening. The bottom end includes a bottom opening. The longitudinal portion includes a longitudinal bore extending between the top opening and the bottom opening. The transverse portion includes a front side and a rear side. The front side includes a front port. The rear side includes a rear port. The transverse portion includes a transverse bore extending between the front port and the rear port. At least a portion of the front side of the transverse portion is threaded. At least a portion of the rear side of the transverse portion is threaded. The longitudinal bore in the longitudinal portion is in fluid communication with the transverse bore in the transverse portion. The front port assembly includes a front glass module and a front nut module. The front glass module includes a front port gasket, a front glass disk, and a front glass washer. The front glass disk is formed from C-plane sapphire. The front nut module includes a front nut washer and a front nut. At least a portion of the front nut is threaded. The threaded portion of the front nut is operable to engage the threaded portion of the front side of the transverse portion and retain the front glass module in the front port. The rear port assembly includes a rear glass module and a rear nut module. The rear glass module includes a rear port gasket, a rear glass disk, and a rear glass washer. The rear glass disk is formed from C-plane sapphire. The rear nut module includes a rear nut washer and a rear nut. At least a portion of the rear nut is threaded. The threaded portion of the rear nut is operable to engage the threaded portion of the rear side of the transverse portion and retain the rear glass module in the rear port.

In an exemplary embodiment, the liquid level gage comprises a gage body assembly. The gage body assembly includes a body, a front port assembly, and a rear port assembly. The body includes a longitudinal portion and a transverse portion. The longitudinal portion includes a top end and a bottom end. The top end includes a top opening. The bottom end includes a bottom opening. The longitudinal portion includes a longitudinal bore extending between the top opening and the bottom opening. The transverse portion includes a front side and a rear side. The front side includes a front port. The rear side includes a rear port. The transverse portion includes a transverse bore extending between the front port and the rear port. At least a portion of the front side of the transverse portion is threaded. At least a portion of the rear side of the transverse portion is threaded. The longitudinal bore in the longitudinal portion is in fluid communication with the transverse bore in the transverse portion. The front port assembly includes a front glass module and a front nut module. The front glass module includes a front port gasket, a front receiving cup, a front inner glass gasket, a front glass disk, a front outer glass gasket, and a front glass washer. The front port gasket is generally disk-shaped. The front receiving cup is generally cylindrical shaped. The front inner glass gasket is generally disk-shaped. The front glass disk is generally cylinder shaped. The front glass disk is formed from C-plane sapphire. The front outer glass gasket is generally disk-shaped. The front glass washer is generally disk-shaped. The front nut module includes a front nut washer and a front nut. The front nut washer is generally disk-shaped. At least a portion of the front nut is threaded. The threaded portion of the front nut is operable to engage the threaded portion of the front side of the transverse portion and retain the front glass module in the front port. The rear port assembly includes a rear glass module and a rear nut module. The rear glass module includes a rear port gasket, a rear receiving cup, a rear inner glass gasket, a rear glass disk, a rear outer glass gasket, and a rear glass washer. The rear port gasket is generally disk-shaped. The rear receiving cup is generally cylindrical shaped. The rear inner glass gasket is generally disk-shaped. The rear glass disk is generally cylinder shaped. The rear glass disk is formed from C-plane sapphire. The rear outer glass gasket is generally disk-shaped. The rear glass washer is generally disk-shaped. The rear nut module includes a rear nut washer and a rear nut. The rear nut washer is generally disk-shaped. At least a portion of the rear nut is threaded. The threaded portion of the rear nut is operable to engage the threaded portion of the rear side of the transverse portion and retain the rear glass module in the rear port.

In an exemplary embodiment, the liquid level gage comprises a hood assembly, a liquid column assembly, and an illuminator assembly. The hood assembly includes a hood housing and a viewing lens. The liquid column assembly includes an upper process connection, a lower process connection, and a gage body assembly. The gage body assembly includes a body, a front port assembly, and a rear port assembly. The body includes a longitudinal portion and a transverse portion. The longitudinal portion includes a top end and a bottom end. The top end includes a top opening. The bottom end includes a bottom opening. The longitudinal portion includes a longitudinal bore extending between the top opening and the bottom opening. The transverse portion includes a front side and a rear side. The front side includes a front port. The rear side includes a rear port. The transverse portion includes a transverse bore extending between the front port and the rear port. At least a portion of the front side of the transverse portion is threaded. At least a portion of the rear side of the transverse portion is threaded. The longitudinal bore in the longitudinal portion is in fluid communication with the transverse bore in the transverse portion. The front port assembly includes a front glass module and a front nut module. The front glass module includes a front port gasket, a front glass disk, and a front glass washer. The front glass disk is generally cylinder shaped. The front glass disk is formed from C-plane sapphire. The front nut module includes a front nut washer and a front nut. At least a portion of the front nut is threaded. The threaded portion of the front nut is operable to engage the threaded portion of the front side of the transverse portion and retain the front glass module in the front port. The rear port assembly includes a rear glass module and a rear nut module. The rear glass module includes a rear port gasket, a rear glass disk, and a rear glass washer. The rear glass disk is formed from C-plane sapphire. The rear nut module includes a rear nut washer and a rear nut. At least a portion of the rear nut is threaded. The threaded portion of the rear nut is operable to engage the threaded portion of the rear side of the transverse portion and retain the rear glass module in the rear port. The illuminator assembly includes an illuminator housing, an illuminator, and a power supply.

### BRIEF DESCRIPTION OF THE DRAWINGS

FIGS. 1a-1c are views of a liquid level gage according to an exemplary embodiment of the present invention, the liquid level gage including a hood assembly, a liquid column assembly, and an illuminator assembly—FIG. 1a is a front, right side perspective view, FIG. 1b is a front, right side perspective view with a side panel of the illuminator assembly removed, and FIG. 1c is a front, right side perspective view with the hood assembly removed;

FIG. 2 is a front, right side perspective view of the liquid column assembly of the liquid level gage of FIGS. 1a-1c, the liquid column assembly including a plurality of gage body assemblies;

FIGS. 3a-3c are views of one gage body assembly of the liquid column assembly of FIG. 2, the gage body assembly including a body, a front port assembly, and a rear port assembly, each of the front port assembly and the rear port assembly including a glass module and a nut module—FIG. 3a is a right side elevational view, FIG. 3b is a cross-sectional view taken along the line 3b-3b in FIG. 3a, and FIG. 3c is a partially exploded perspective view;

FIGS. 4a-4c are views of one glass module of the front port assembly and the rear port assembly of FIGS. 3a-3c-FIG. 4a is a front elevational view of the glass module of the front port assembly and a rear elevational view of the glass module of the rear port assembly, FIG. 4b is a cross-sectional view taken along the line 4b-4b in FIG. 4a, and FIG. 4c is an exploded perspective view; and

FIGS. 5a-5c are views of one nut module of the front port assembly and the rear port assembly of FIGS. 3a-3c-FIG. 5a is a front elevational view of the nut module of the front port assembly and a rear elevational view of the nut module of the rear port assembly, FIG. 5b is a cross-sectional view taken along the line 5b-5b in FIG. 5a, and FIG. 5c is an exploded perspective view.

### DETAILED DESCRIPTION

The present invention provides a liquid level gage with C-plane sapphire. Liquid level gages are used to determine the level of liquid in vessels. In an exemplary embodiment, the liquid level gage is a ported style liquid level gage. In an exemplary embodiment, the vessel is a steam vessel, such as a boiler.

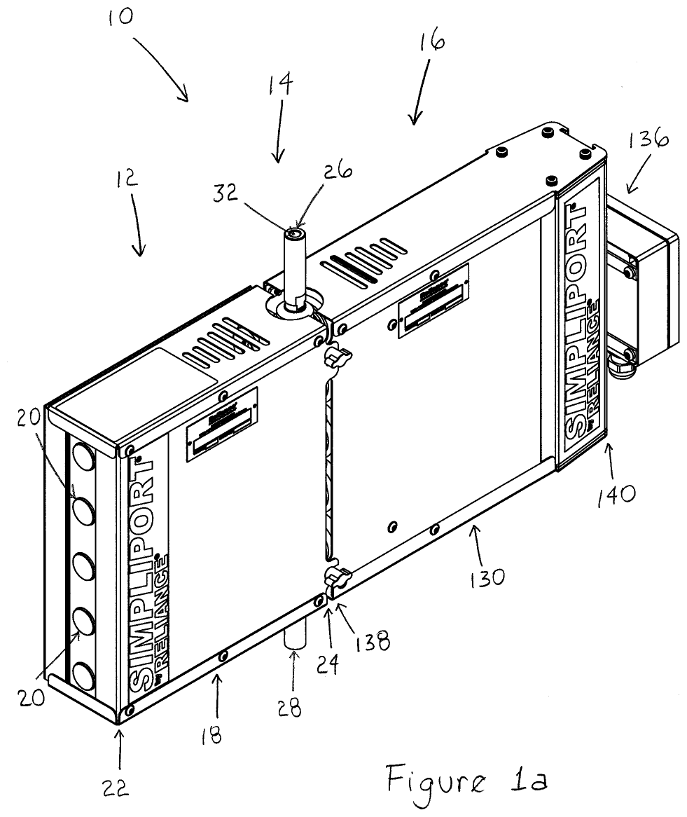

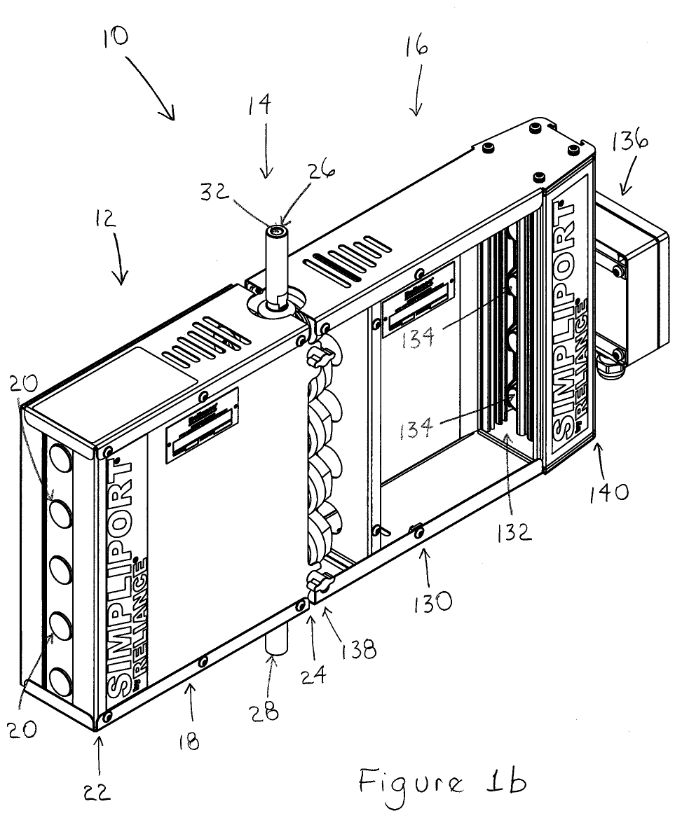

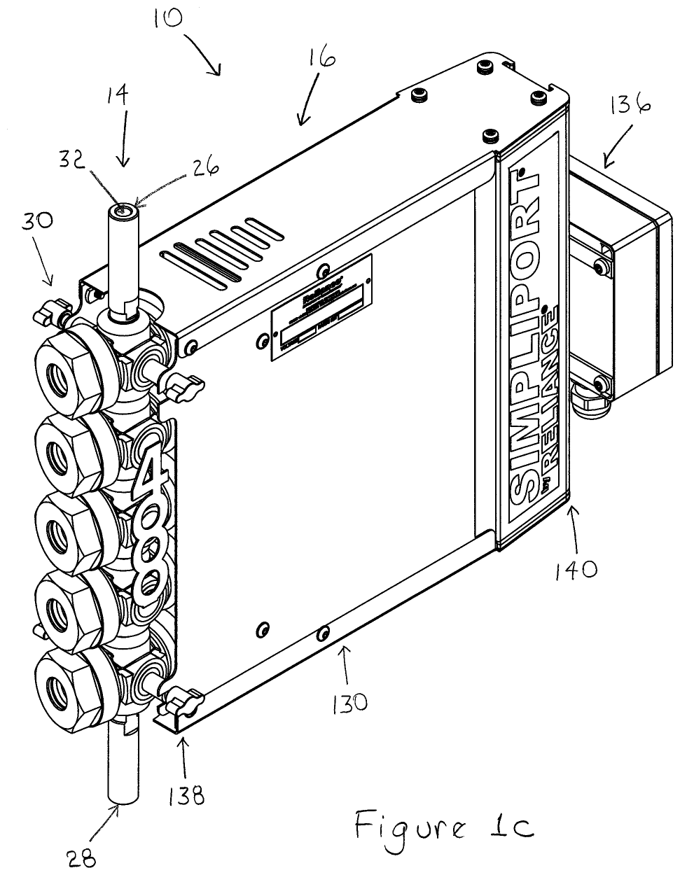

An exemplary embodiment of a liquid level gage 10 of the present invention is illustrated in FIGS. 1a-5c. In the exemplary embodiment, the liquid level gage 10 includes a hood assembly 12, a liquid column assembly 14, and an illuminator assembly 16. In an exemplary embodiment, the liquid whose level is to be determined is water.

An exemplary embodiment of the hood assembly 12 is shown in detail in FIGS. 1a-1b. In an exemplary embodiment, the hood assembly 12 includes a hood housing 18 and a plurality of viewing lenses 20. In an exemplary embodiment, the hood housing 18 includes a first or front end 22 and a second or rear end 24. In an exemplary embodiment, the hood housing 18 is generally rectangular prism shaped. In an exemplary embodiment, the hood assembly 12 includes between five (5) and ten (10) viewing lenses 20. In the illustrated embodiment, the hood assembly 12 includes five (5) viewing lenses 20. However, one of ordinary skill in the art will appreciate that the hood assembly 12 could include any number of viewing lenses 20. The components of the hood assembly 12 are well-known in the art and will not be described in greater detail.

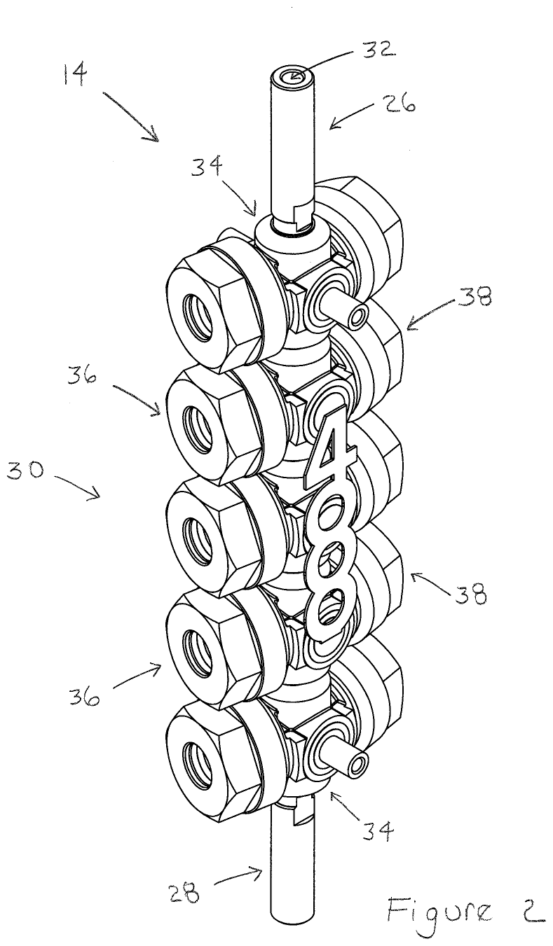

An exemplary embodiment of the liquid column assembly 14 is shown in detail in FIGS. 1a-1c and 2. In an exemplary embodiment, the liquid column assembly 14 is operable to be connected to the hood assembly 12 and the illuminator assembly 16. In an exemplary embodiment, the liquid column assembly 14 includes a first or upper process connection 26, a second or lower process connection 28, and a plurality of gage body assemblies 30. In an exemplary embodiment, the liquid column assembly 14 is operable to fluidly communicate with a vessel (not shown) through the upper process connection 26 and the lower process connection 28. In an exemplary embodiment, the liquid column assembly 14 includes between five (5) and ten (10) gage body assemblies 30. In the illustrated embodiment, the liquid column assembly 14 includes five (5) gage body assemblies 30. However, one of ordinary skill in the art will appreciate that the liquid column assembly 14 could include any number of gage body assemblies 30. In an exemplary embodiment, one gage body assembly 30 corresponds to each viewing lens 20.

An exemplary embodiment of the upper process connection 26 is shown in detail in FIGS. 1a-1c and 2. An exemplary embodiment of the lower process connection 28 is shown in detail in FIGS. 1a-1c and 2. In the illustrated embodiment, the lower process connection 28 is a mirror image of the upper process connection 26. Therefore, the below description will generically refer to the process connection 26/28 since it applies to the upper process connection 26 and the lower process connection 28. In an exemplary embodiment, the process connection 26/28 is generally cylindrical shaped and includes a longitudinal bore 32 extending therethrough. However, one of ordinary skill in the art will appreciate that the process connection 26/28 could have a different shape. Moreover, one of ordinary skill in the art will appreciate that the upper process connection 26 may not be a mirror image of the lower process connection 28. In an exemplary embodiment, the process connection 26/28 is made from stainless steel. However, one of ordinary skill in the art will appreciate that the process connection 26/28 could be made from other materials.

An exemplary embodiment of the gage body assembly 30 is shown in detail in FIGS. 1c, 2, and 3a-3c. In an exemplary embodiment, each gage body assembly 30 includes a body 34, a front port assembly 36, and a rear port assembly 38. In an exemplary embodiment, one front port assembly 36 and one rear port assembly 38 are operable to be connected to each body 34.

An exemplary embodiment of the body 34 is shown in detail in FIGS. 1c, 2, and 3a-3c. In an exemplary embodiment, the body 34 includes a longitudinal portion 40 and a transverse portion 42.

In an exemplary embodiment, the longitudinal portion 40 includes a first or top end 44 and a second or bottom end 46. In an exemplary embodiment, the top end 44 includes a first or top opening 48. In an exemplary embodiment, the bottom end 46 includes a second or bottom opening 50. In an exemplary embodiment, the longitudinal portion 40 includes a longitudinal bore 52 extending between the top opening 48 and the bottom opening 50. In an exemplary embodiment, the longitudinal portion 40 has an inner surface 54 and an outer surface 56.

In an exemplary embodiment, the transverse portion 42 includes a first or front side 58 and a second or rear side 60. In an exemplary embodiment, the front side 58 includes a first or front opening or port 62 and a plurality of first or front notches 64. In an exemplary embodiment, the rear side 60 includes a second or rear opening or port 66 and a plurality of second or rear notches 68. In an exemplary embodiment, the transverse portion 42 includes a transverse bore 70 extending between the front port 62 and the rear port 66. In an exemplary embodiment, the transverse portion 42 has an inner surface 72 and an outer surface 74.

In an exemplary embodiment, at least a portion of the front side 58 of the transverse portion 42 is threaded. In the illustrated embodiment, at least a portion of the inner surface 72 of the front side 58 of the transverse portion 42 is threaded. In the illustrated embodiment, at least a portion of the outer surface 74 of the front side 58 of the transverse portion 42 is threaded. In an exemplary embodiment, at least a portion of the rear side 60 of the transverse portion 42 is threaded. In the illustrated embodiment, at least a portion of the inner surface 72 of the rear side 60 of the transverse portion 42 is threaded. In the illustrated embodiment, at least a portion of the outer surface 74 of the rear side 60 of the transverse portion 42 is threaded. In an exemplary embodiment, the threaded portions on the inner surface 72 of the front side 58 and the inner surface 72 of the rear side 60 are operable to limit reflection of light in the transverse bore 70. In an exemplary embodiment, the threaded portions on the outer surface 74 of the front side 58 and the outer surface 74 of the rear side 60 are operable to engage with threaded portions on the front port assembly 36 and the rear port assembly 38, respectively.

In an exemplary embodiment, the longitudinal bore 52 in the longitudinal portion 40 is in fluid communication with the transverse bore 70 in the transverse portion 42. In an exemplary embodiment, the body 34 is made from stainless steel. However, one of ordinary skill in the art will appreciate that the body 34 could be made from other materials. In an exemplary embodiment, the bodies 34 are connected to one another using welding. However, one of ordinary skill in the art will appreciate that the bodies 34 could be connected to one another using other connection techniques.

An exemplary embodiment of the front port assembly 36 is shown in detail in FIGS. 1c, 2, 3a-3c, 4a-4c, and 5a-5c. An exemplary embodiment of the rear port assembly 38 is shown in detail in FIGS. 1c, 2, 3a-3c, 4a-4c, and 5a-5c. The rear port assembly 38 is a mirror image of the front port assembly 36. Therefore, the below description will generically refer to the port assembly 36/38 since it applies to the front port assembly 36 and the rear port assembly 38. In an exemplary embodiment, the port assembly 36/38 includes a glass module 76 and a nut module 78.

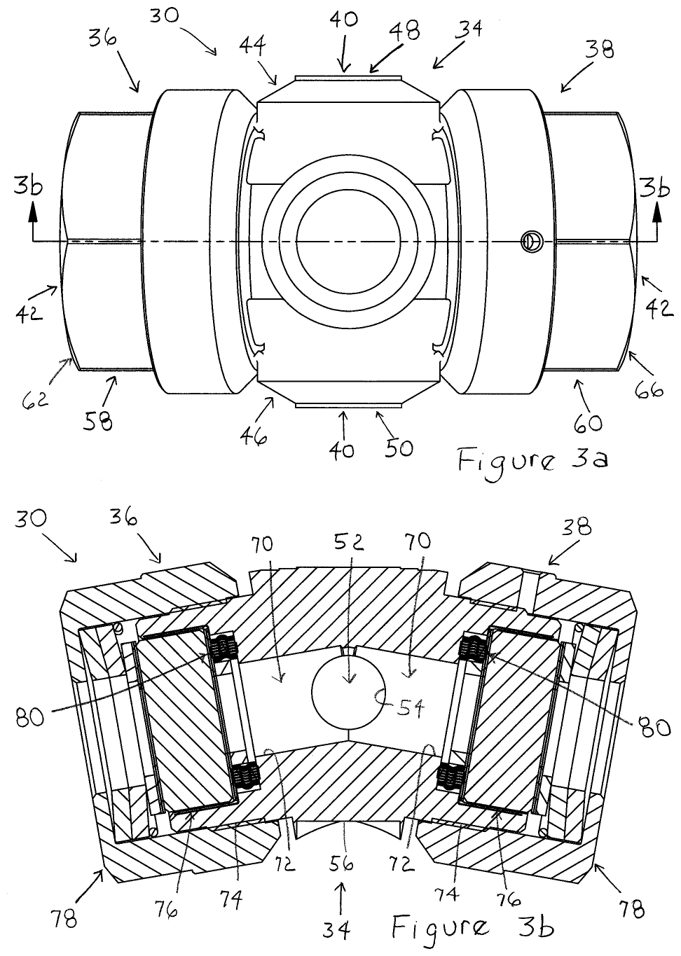

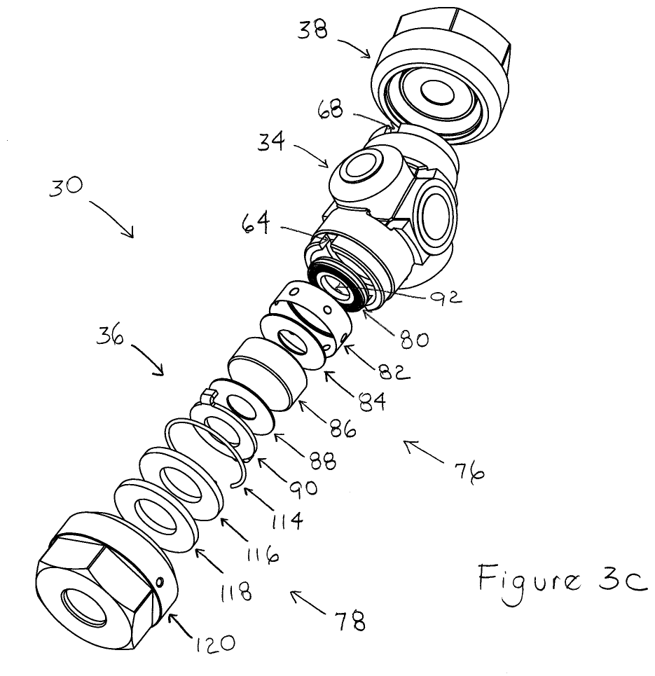

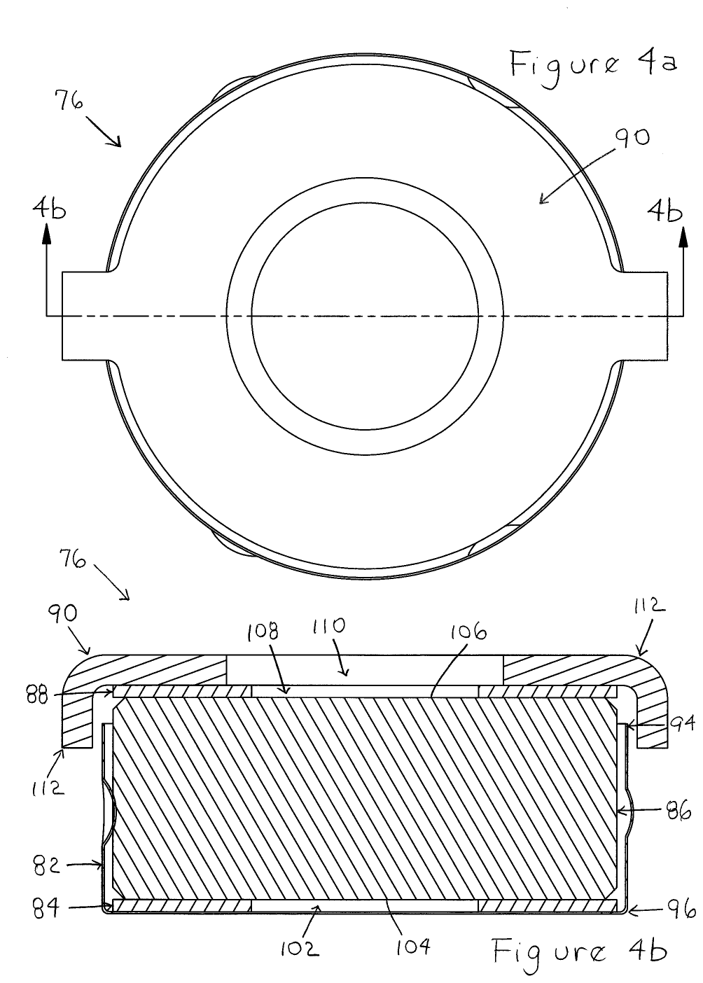

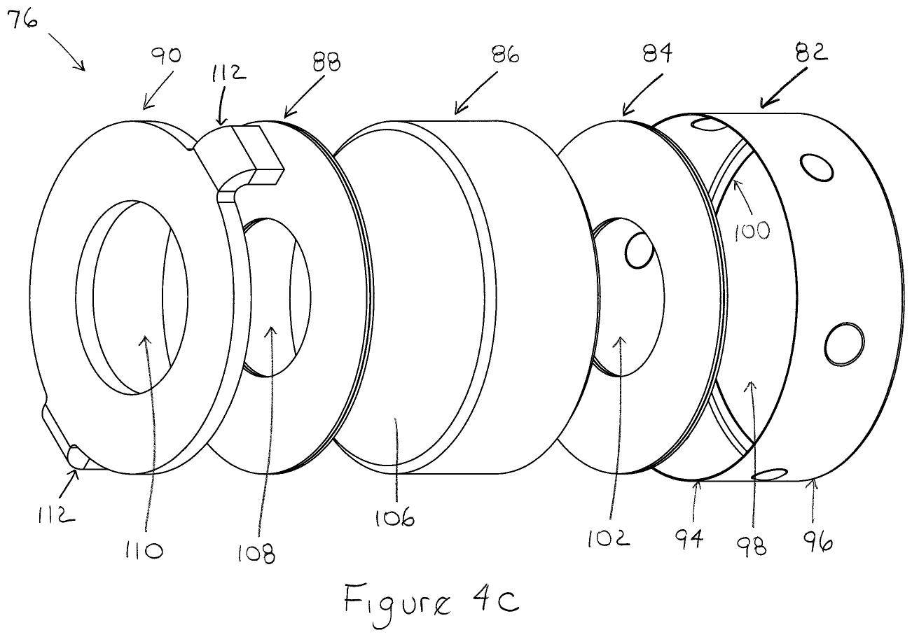

An exemplary embodiment of the glass module 76 is shown in detail in FIGS. 3b-3c and 4a-4c. In an exemplary embodiment, the glass module 76 includes a port gasket 80, a receiving cup 82, a first or inner glass gasket 84, a glass disk 86, a second or outer glass gasket 88, and a glass washer 90.

An exemplary embodiment of the port gasket 80 is shown in detail in FIGS. 3b-3c. In an exemplary embodiment, the port gasket 80 is operable to create a seal between the glass module 76 and the body 34. In an exemplary embodiment, the port gasket 80 is generally disk-shaped and includes a central opening 92 extending therethrough. In an exemplary embodiment, the port gasket 80 is a spiral wound gasket. However, one of ordinary skill in the art will appreciate that the port gasket 80 could be another type of gasket.

An exemplary embodiment of the receiving cup 82 is shown in detail in FIGS. 3b-3c and 4a-4c. In an exemplary embodiment, the receiving cup 82 is operable to receive and align some components of the glass module 76. In an exemplary embodiment, the receiving cup 82 includes a first or outer end 94 and a second or inner end 96. In an exemplary embodiment, the receiving cup 82 is generally cylindrical shaped, includes a central opening 98 extending therethrough, and includes a shoulder 100 extending into the central opening 98 from a perimeter of the rear end 96. In an exemplary embodiment, the receiving cup 82 is made from stainless steel. However, one of ordinary skill in the art will appreciate that the receiving cup 82 could be made from other materials.

An exemplary embodiment of the inner glass gasket 84 is shown in detail in FIGS. 3b-3c and 4b-4c. In an exemplary embodiment, the inner glass gasket 84 is operable to protect the glass disk 86. In an exemplary embodiment, the inner glass gasket 84 is generally disk-shaped and includes a central opening 102 extending therethrough. In an exemplary embodiment, the inner glass gasket 84 is a cushion gasket. In an exemplary embodiment, the inner glass gasket 84 is made from GHR. However, one of ordinary skill in the art will appreciate that the inner glass gasket 84 could be made from other materials.

An exemplary embodiment of the glass disk 86 is shown in detail in FIGS. 3b-3c and 4a-4c. In an exemplary embodiment, the glass disk 86 is operable to allow the transmission of light therethrough. In an exemplary embodiment, the glass disk 86 is generally cylinder shaped. In an exemplary embodiment, the glass disk 86 includes an inner face 104 and an outer face 106. In an exemplary embodiment, the glass disk 86 is made from C-plane sapphire, also referred to as zero degree sapphire. C-plane sapphire is a synthetic, transparent sapphire made from sapphire crystals. An orientation or angle of the sapphire crystals from an optical or C-axis of the sapphire crystals is zero (0) degrees. The optical or C-axis of the sapphire crystals is perpendicular to the inner face 104 and the outer face 106 of the glass disk 86. C-plane sapphire provides better mechanical and optical properties. More specifically, C-plane sapphire provides durability and clear viewing.

An exemplary embodiment of the outer glass gasket 88 is shown in detail in FIGS. 3b-3c and 4b-4c. In an exemplary embodiment, the outer glass gasket 88 is operable to protect the glass disk 86. In an exemplary embodiment, the outer glass gasket 88 is generally disk-shaped and includes a central opening 108 extending therethrough. In an exemplary embodiment, the outer glass gasket 88 is a cushion gasket. In an exemplary embodiment, the outer glass gasket 88 is made from copper. However, one of ordinary skill in the art will appreciate that the outer glass gasket 88 could be made from other materials.

An exemplary embodiment of the glass washer 90 is shown in detail in FIGS. 3b-3c and 4a-4c. In an exemplary embodiment, the glass washer 90 is operable to distribute a load on the glass module 76 and prevent rotation of the glass module 76. In an exemplary embodiment, the glass washer 90 is generally disk-shaped, includes a central opening 110 extending therethrough, and includes a plurality of tabs 112 extending from a perimeter thereof. In the illustrated embodiment, the glass washer 90 includes two (2) opposing generally L-shaped tabs 112. However, one of ordinary skill in the art will appreciate that the glass washer 90 could include any number of tabs 112, and the tabs 112 could have a different shape. In an exemplary embodiment, the glass washer 90 is a lug washer. However, one of ordinary skill in the art will appreciate that the glass washer 90 could be another type of washer. In an exemplary embodiment, the glass washer 90 is made from stainless steel. However, one of ordinary skill in the art will appreciate that the glass washer 90 could be made from other materials.

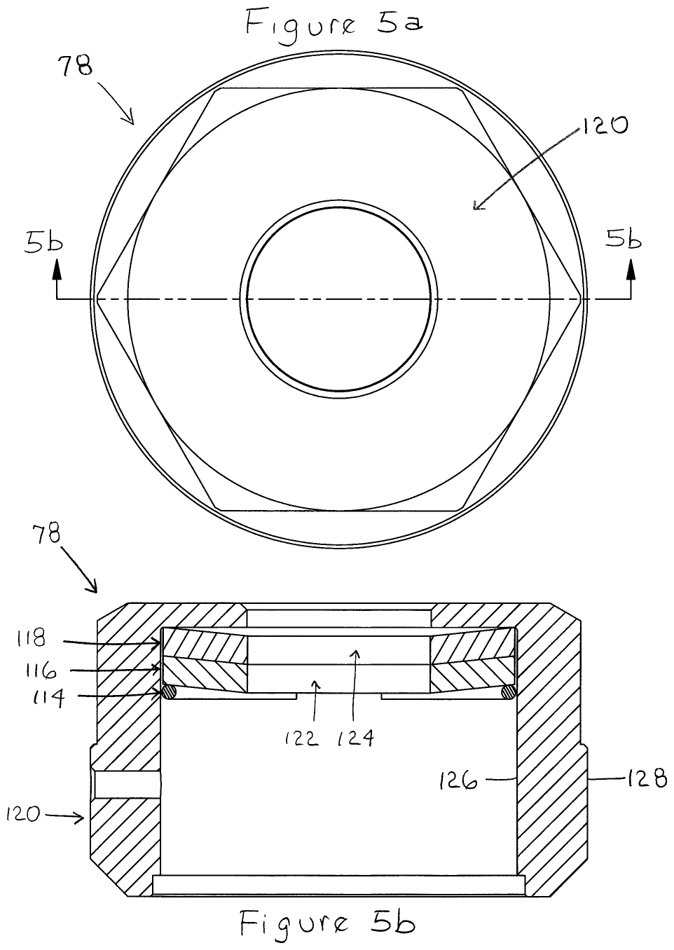

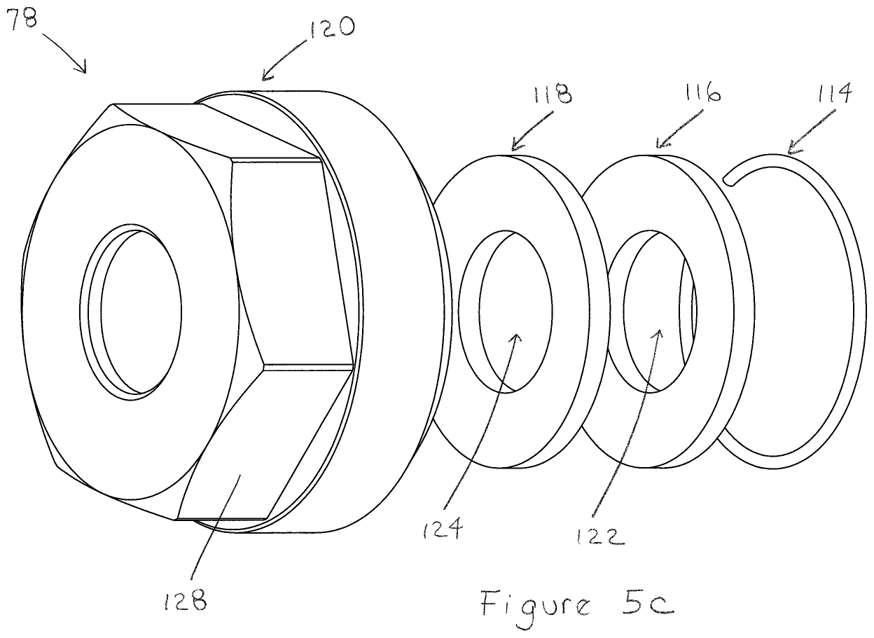

An exemplary embodiment of the nut module 78 is shown in detail in FIGS. 3a-3c and 5a-5c. In an exemplary embodiment, the nut module 78 includes a clip 114, a first or inner nut washer 116, a second or outer nut washer 118, and a nut 120.

An exemplary embodiment of the clip 114 is shown in detail in FIGS. 3b-3c and 5b-5c. In an exemplary embodiment, the clip 114 is operable to retain the inner nut washer 116 and the outer nut washer 118 in the nut 120. In an exemplary embodiment, the clip 114 is generally C-shaped. In an exemplary embodiment, the clip 114 is a spring clip. In an exemplary embodiment, the clip 114 is made from stainless steel. However, one of ordinary skill in the art will appreciate that the clip 114 could be made from other materials.

An exemplary embodiment of the inner nut washer 116 is shown in detail in FIGS. 3b-3c and 5b-5c. In an exemplary embodiment, the inner nut washer 116 is operable to apply a load on the glass module 76. In an exemplary embodiment, the inner nut washer 116 is generally disk-shaped and includes a central opening 122 extending therethrough. In an exemplary embodiment, the inner nut washer 116 is a spring washer. In an exemplary embodiment, the inner nut washer 116 is a Belleville washer. However, one of ordinary skill in the art will appreciate that the inner nut washer 116 could be another type of washer.

An exemplary embodiment of the outer nut washer 118 is shown in detail in FIGS. 3b-3c and 5b-5c. In an exemplary embodiment, the outer nut washer 118 is operable to apply a load on the glass module 76. In an exemplary embodiment, the outer nut washer 118 is generally disk-shaped and includes a central opening 124 extending therethrough. In an exemplary embodiment, the outer nut washer 118 is a spring washer. In an exemplary embodiment, the outer nut washer 118 is a Belleville washer. However, one of ordinary skill in the art will appreciate that the outer nut washer 118 could be another type of washer.

An exemplary embodiment of the nut 120 is shown in detail in FIGS. 3a-3c and 5a-5c. In an exemplary embodiment, the nut 120 is operable to create a load to seal the glass module 76 in the body 34. In an exemplary embodiment, the nut 120 includes an inner surface 126 and an outer surface 128. In an exemplary embodiment, at least a portion of the nut 120 is threaded. In the illustrated embodiment, at least a portion of the inner surface 126 of the nut 120 is threaded. In the illustrated embodiment, the threaded portion on the inner surface 126 of the nut 120 is operable to engage with the threaded portions on the outer surface 74 of the front side 58 and the outer surface 74 of the rear side 60 of the transverse portion 42 of the body 34 and retain the glass module 76 in the front port 62 in the front side 58 and the rear port 66 in the rear side 60 of the transverse portion 42 of the body 34. In an exemplary embodiment, the nut 120 is a packing nut. However, one of ordinary skill in the art will appreciate that the nut 120 could be another type of nut.

An exemplary embodiment of the illuminator assembly 16 is shown in detail in FIG. 1b. In an exemplary embodiment, the illuminator assembly 16 includes an illuminator housing 130, an illuminator 132, and a power supply 136. In an exemplary embodiment, the illuminator housing 130 includes a first or front end 138 and a second or rear end 140. In an exemplary embodiment, the illuminator housing 130 is generally rectangular prism shaped. In an exemplary embodiment, the power supply 136 is electrically connected to the illuminator 132. In an exemplary embodiment, the power supply 136 is a low voltage direct current (DC) power supply 136. The components of the illuminator assembly 16 are well-known in the art and most of these components will not be described in greater detail. Only the illuminator 132 will be described in greater detail.

In an exemplary embodiment, the illuminator 132 is operable to be connected to the second or rear end 140 of the illuminator housing 130. In an exemplary embodiment, the illuminator 132 includes a plurality of light source assemblies 134 (e.g., a light emitting diode (LED) assembly). In an exemplary embodiment, half of the light source assemblies 134 emit a first color light (e.g., green), and half of the light source assemblies 134 emit a second color light (e.g., red). In an exemplary embodiment, a pair of bi-color light source assemblies 134 (i.e., one light source assembly 134 emitting the first color light and one light source assembly 134 emitting the second color light) corresponds to each gage body assembly 30 and each viewing lens 20. In an exemplary embodiment, each pair of bi-colored light source assemblies 134 is oriented with respect to the corresponding body 34 in such a way that the first color light (e.g., green) passes through the corresponding gage body assembly 30 when a liquid is present in the corresponding body 34 and the second color light (e.g., red) passes through the corresponding gage body assembly 30 when a non-liquid is present in the corresponding body 34. The orientation of the components of the liquid level gage 10 is based on principles of light refraction. Light refracts through a liquid (e.g., water) differently than it refracts through a non-liquid (e.g., steam or air). Illuminators for liquid level gages are well known in the art and will not be described in greater detail.

The liquid level gage 10 can be assembled. The assembled liquid level gage 10 can be installed in a process. In an exemplary embodiment, the liquid level gage 10 is connected to a vessel, such as a drum or a tank. The assembly and installation of liquid level gages are well-known in the art and will not be described in greater detail.

During operation of the liquid level gage 10, liquid from the vessel enters the liquid column assembly 14 to a level that corresponds to the level of liquid in the vessel. The light source assemblies 134 emit light toward the rear port assemblies 38. The light passes through the illuminator housing 130 and the rear port assemblies 38 into the bodies 34. If liquid is present in the body 34, the first color light (e.g., green) passes through the body 34 and the front port assembly 36 where it can be observed by a user through the viewing lens 20, but the second color light (e.g., red) does not. If a non-liquid is present in the body 34, the second color light (e.g., red) passes through the body 34 and the front port assembly 36 where it can be observed by the user through the viewing lens 20, but the first color light (e.g., green) does not. The level of liquid in the liquid column assembly 14 is shown by the viewing lenses 20 displaying the first color light (e.g., green). Since the level of liquid in the liquid column assembly 14 corresponds to the level of liquid in the vessel, the user can determine the level of liquid in the vessel by observing the level of liquid in the liquid column assembly 14. The operation of liquid level gages is well known in the art and will not be described in greater detail.

In an exemplary embodiment, the liquid level gage 10 is operable to withstand a temperature of at least 600 degrees Fahrenheit (° F.). In an exemplary embodiment, the liquid level gage 10 is operable to withstand a temperature of at least 625 degrees Fahrenheit (° F.). In an exemplary embodiment, the liquid level gage 10 is operable to withstand a temperature of at least 650 degrees Fahrenheit (° F.). In an exemplary embodiment, the liquid level gage 10 is operable to withstand a temperature of at least 675 degrees Fahrenheit (° F.). In an exemplary embodiment, the liquid level gage 10 is operable to withstand a temperature of up to 700 degrees Fahrenheit (° F.).

In an exemplary embodiment, the liquid level gage 10 is operable to withstand a pressure of at least 1750 pounds per square inch (psi). In an exemplary embodiment, the liquid level gage 10 is operable to withstand a pressure of at least 2000 pounds per square inch (psi). In an exemplary embodiment, the liquid level gage 10 is operable to withstand a pressure of at least 2250 pounds per square inch (psi). In an exemplary embodiment, the liquid level gage 10 is operable to withstand a pressure of at least 2500 pounds per square inch (psi). In an exemplary embodiment, the liquid level gage 10 is operable to withstand a pressure of at least 2750 pounds per square inch (psi). In an exemplary embodiment, the liquid level gage 10 is operable to withstand a pressure of up to 3000 pounds per square inch (psi).

One of ordinary skill in the art will now appreciate that the present invention provides a liquid level gage with C-plane sapphire. Although the present invention has been shown and described with reference to particular embodiments, equivalent alterations and modifications will occur to those skilled in the art upon reading and understanding this specification. The present invention includes all such equivalent alterations and modifications and is limited only by the scope of the following claims in light of their full scope of equivalents.

What is claimed is:

1. A liquid level gage, comprising:
a gage body assembly, the gage body assembly including a body, a front port assembly, and a rear port assembly;
the body including a longitudinal portion and a transverse portion, the longitudinal portion including a top end and a bottom end, the top end including a top opening, the bottom end including a bottom opening, the longitudinal portion including a longitudinal bore extending between the top opening and the bottom opening, the transverse portion including a front side and a rear side, the front side including a front port, the rear side including a rear port, the transverse portion including a transverse bore extending between the front port and the rear port, at least a portion of the front side of the transverse portion being threaded, at least a portion of the rear side of the transverse portion being threaded, the longitudinal bore in the longitudinal portion being in fluid communication with the transverse bore in the transverse portion;
the front port assembly including a front glass module and a front nut module,
the front glass module including a front port gasket, a front glass disk, and a front glass washer,
the front glass disk being formed from C-plane sapphire,
the front nut module including a front nut washer and a front nut,
at least a portion of the front nut being threaded, the threaded portion of the front nut operable to engage the threaded portion of the front side of the transverse portion and retain the front glass module in the front port; and
the rear port assembly including a rear glass module and a rear nut module,
the rear glass module including a rear port gasket, a rear glass disk, and a rear glass washer,
the rear glass disk being formed from C-plane sapphire,
the rear nut module including a rear nut washer and a rear nut,
at least a portion of the rear nut being threaded, the threaded portion of the rear nut operable to engage the threaded portion of the rear side of the transverse portion and retain the rear glass module in the rear port.

2. The liquid level gage of claim 1, wherein the liquid level gage is operable to withstand a pressure of at least 1750 pounds per square inch.

3. The liquid level gage of claim 1, wherein the liquid level gage is operable to withstand a pressure of at least 2000 pounds per square inch.

4. The liquid level gage of claim 1, wherein the liquid level gage is operable to withstand a pressure of at least 2250 pounds per square inch.

5. The liquid level gage of claim 1, wherein the liquid level gage is operable to withstand a pressure of at least 2500 pounds per square inch.

6. The liquid level gage of claim 1, wherein the liquid level gage is operable to withstand a pressure of at least 2750 pounds per square inch.

7. The liquid level gage of claim 1, wherein the liquid level gage is operable to withstand a pressure of up to 3000 pounds per square inch.

8. A liquid level gage, comprising:
a gage body assembly, the gage body assembly including a body, a front port assembly, and a rear port assembly;
the body including a longitudinal portion and a transverse portion, the longitudinal portion including a top end and a bottom end, the top end including a top opening, the bottom end including a bottom opening, the longitudinal portion including a longitudinal bore extending between the top opening and the bottom opening, the transverse portion including a front side and a rear side, the front side including a front port, the rear side including a rear port, the transverse portion including a transverse bore extending between the front port and the rear port, at least a portion of the front side of the transverse portion being threaded, at least a portion of the rear side of the transverse portion being threaded, the longitudinal bore in the longitudinal portion being in fluid communication with the transverse bore in the transverse portion;
the front port assembly including a front glass module and a front nut module,
the front glass module including a front port gasket, a front receiving cup, a front inner glass gasket, a front glass disk, a front outer glass gasket, and a front glass washer,
the front port gasket being generally disk-shaped,
the front receiving cup being generally cylindrical shaped,
the front inner glass gasket being generally disk-shaped,
the front glass disk being generally cylinder shaped, the front glass disk being formed from C-plane sapphire,
the front outer glass gasket being generally disk-shaped,
the front glass washer being generally disk-shaped,
the front nut module including a front nut washer and a front nut,
the front nut washer being generally disk-shaped,
at least a portion of the front nut being threaded, the threaded portion of the front nut operable to engage the threaded portion of the front side of the transverse portion and retain the front glass module in the front port; and
the rear port assembly including a rear glass module and a rear nut module,
the rear glass module including a rear port gasket, a rear receiving cup, a rear inner glass gasket, a rear glass disk, a rear outer glass gasket, and a rear glass washer,
the rear port gasket being generally disk-shaped,
the rear receiving cup being generally cylindrical shaped,
the rear inner glass gasket being generally disk-shaped,
the rear glass disk being generally cylinder shaped, the rear glass disk being formed from C-plane sapphire,
the rear outer glass gasket being generally disk-shaped,
the rear glass washer being generally disk-shaped,
the rear nut module including a rear nut washer and a rear nut,
the rear nut washer being generally disk-shaped,
at least a portion of the rear nut being threaded, the threaded portion of the rear nut operable to engage the threaded portion of the rear side of the transverse portion and retain the rear glass module in the rear port.

9. The liquid level gage of claim 8, wherein the liquid level gage is operable to withstand a pressure of at least 1750 pounds per square inch.

10. The liquid level gage of claim 8, wherein the liquid level gage is operable to withstand a pressure of at least 2000 pounds per square inch.

11. The liquid level gage of claim 8, wherein the liquid level gage is operable to withstand a pressure of at least 2250 pounds per square inch.

12. The liquid level gage of claim 8, wherein the liquid level gage is operable to withstand a pressure of at least 2500 pounds per square inch.

13. The liquid level gage of claim 8, wherein the liquid level gage is operable to withstand a pressure of at least 2750 pounds per square inch.

14. The liquid level gage of claim 8, wherein the liquid level gage is operable to withstand a pressure of up to 3000 pounds per square inch.

15. A liquid level gage, comprising:
a hood assembly, the hood assembly including a hood housing and a viewing lens;
a liquid column assembly, the liquid column assembly including an upper process connection, a lower process connection, and a gage body assembly;
the gage body assembly including a body, a front port assembly, and a rear port assembly,
the body including a longitudinal portion and a transverse portion, the longitudinal portion including a top end and a bottom end, the top end including a top opening, the bottom end including a bottom opening, the longitudinal portion including a longitudinal bore extending between the top opening and the bottom opening, the transverse portion including a front side and a rear side, the front side including a front port, the rear side including a rear port, the transverse portion including a transverse bore extending between the front port and the rear port, at least a portion of the front side of the transverse portion being threaded, at least a portion of the rear side of the transverse portion being threaded, the longitudinal bore in the longitudinal portion being in fluid communication with the transverse bore in the transverse portion;
the front port assembly including a front glass module and a front nut module,
the front glass module including a front port gasket, a front glass disk, and a front glass washer,
the front glass disk being generally cylinder shaped, the front glass disk being formed from C-plane sapphire,
the front nut module including a front nut washer and a front nut,
at least a portion of the front nut being threaded, the threaded portion of the front nut operable to engage the threaded portion of the front side of the transverse portion and retain the front glass module in the front port; and
the rear port assembly including a rear glass module and a rear nut module,
the rear glass module including a rear port gasket, a rear glass disk, and a rear glass washer,
the rear glass disk being formed from C-plane sapphire,
the rear nut module including a rear nut washer and a rear nut,
at least a portion of the rear nut being threaded, the threaded portion of the rear nut operable to engage the threaded portion of the rear side of the transverse portion and retain the rear glass module in the rear port; and
an illuminator assembly, the illuminator assembly including an illuminator housing, an illuminator, and a power supply.

16. The liquid level gage of claim 15, wherein the liquid level gage is operable to withstand a pressure of at least 2000 pounds per square inch.

17. The liquid level gage of claim 15, wherein the liquid level gage is operable to withstand a pressure of at least 2250 pounds per square inch.

18. The liquid level gage of claim 15, wherein the liquid level gage is operable to withstand a pressure of at least 2500 pounds per square inch.

19. The liquid level gage of claim 15, wherein the liquid level gage is operable to withstand a pressure of at least 2750 pounds per square inch.

20. The liquid level gage of claim 15, wherein the liquid level gage is operable to withstand a pressure of up to 3000 pounds per square inch.
